(19) United States
(12) Patent Application Publication
(10) Pub. No.: US 2006/0209833 A1
(43) Pub. Date: Sep. 21, 2006

(54) Communication apparatus and computer program product for communicating with other communication apparatus

(75) Inventor: Seijiro Yoneyama, Kanagawa (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/340,531

(22) Filed: Jan. 27, 2006

(30) Foreign Application Priority Data
Mar. 15, 2005 (JP) 2005-072997

(51) Int. Cl. H04L 12/56

(52) U.S. Cl. 370/392

(57) ABSTRACT

A communication apparatus includes a receiving unit that receives a data signal sent from a network repeater, the data signal including identification information for identifying a network; an identification information extracting unit that extracts identification information from the data signal; a connectivity deciding unit that decides whether a connection to other communication apparatus through the network identified by the identification information is possible; and a storing unit that stores the identification information when the connectivity deciding unit decides that the connection to the other communication apparatus is possible.

### CROSS-REFERENCE TO RELATED APPLICATIONS

This application is based upon and claims the benefit of priority from the prior Japanese Patent Application No. 2005-072997, filed on Mar. 15, 2005; the entire contents of which are incorporated herein by reference.

### BACKGROUND OF THE INVENTION

1. Field of the Invention

The present invention relates to a communication apparatus which stores a network prefix and a default route address for setting a network address in association with each other, a communication method, and a computer program product therefor.

2. Description of the Related Art

In IPv4 (Internet Protocol Version 4) which is a popularly available technique at the present, only one default route can be set. However, in the network environment of IPv6 (Internet Protocol Version 6) which is a next-generation technique, a plurality of default routers can be set. In addition, there can be a network environment in which a plurality of routers notifies a plurality of network prefixes through a router advertisement (RA). In this case, the router advertisement means a message which periodically notifies a network prefix representing an upper bit of a network address required by a communication apparatus in IPv6 to set the network address of the apparatus itself or information such as a default router address.

T. Narten et al., “RFC 2461, Neighbor Discovery for IP Version 6 (IPv6),” [on line], Dec. 1998, retrieved from the Internet: <URL: http://www.ietf.org/rfc/rfc2461.txt>, an operation of the communication apparatus in the network environment is regulated. More specifically, in an environment in which a plurality of default routers are present, the communication apparatus extracts network prefixes and default addresses from all notified router advertisements and manages the network prefixes and the default router addresses by a list. In a communication state, the communication apparatus select an appropriate network prefix and an appropriate default router address to regulate communication. Therefore, the size of the list for managing the network prefixes and the default router addresses can be infinitely expanded.

On the,other hand, in a communication apparatus which is desired to be developed at low cost for an home information appliance having a built-in network communication function, the size of a list of network prefixes and default router addresses preferably has a fixed length.

However, when the list size has the fixed length, all pieces of information cannot be stored in the list in a network environment in which network prefixes and default router addresses the numbers of which are larger than tolerable numbers of the fixed size are notified. For this reason, a network prefix and a default router address for identifying a network to which a server or the like serving as an actually communicatee cannot be stored in the list, and the communication apparatus cannot communicate with the server or the like disadvantageously.

### SUMMARY OF THE INVENTION

According to one aspect of the present invention, a communication apparatus connectable to a network repeater includes a receiving unit that receives a data signal sent from the network repeater, the data signal including identification information for identifying a network; an identification information extracting unit that extracts the identification information from the data signal; a connectivity deciding unit that decides whether a connection to other communication apparatus through the network identified by the identification information is possible; and

a storing unit that stores the identification information when the connectivity deciding unit decides that the connection to the other communication apparatus is possible.

According to another aspect of the present invention, a communication method for communicating between a communication apparatus and other communication apparatus through a network repeater includes receiving a data signal sent from the network repeater , the data signal including identification information for identifying a network; extracting identification information from the data signal; deciding whether a connection of the communication apparatus to the other communication apparatus through the network identified by the identification information is possible; and storing the identification information in a storing unit when it is decided that the connection to the other communication apparatus is possible.

According to still another aspect of the present invention, a computer program product causes a computer to perform the communication method according to the present invention.

### BRIEF DESCRIPTION OF THE DRAWINGS

FIG. 1 is a diagram for explaining the entire configuration of a network including a communication apparatus according to a first embodiment;

FIG. 2 is a diagram for explaining an example of the data structure of a prefix table;

FIG. 3 is a diagram for explaining an example of the data structure of a default router table;

FIG. 4 is a diagram for explaining an example of the data structure of a combination table;

FIG. 5 is a flow chart showing an entire flow of an identification information registering process in the first embodiment;

FIG. 6 is a diagram for explaining an example of the identification information registering process in the first embodiment;

FIG. 7 is a diagram for explaining an example of identification information registered in an identification information storing unit;

FIG. 8 is a diagram for explaining an example of the identification information registering process in the first. embodiment;

FIG. 9 is a diagram for explaining the entire configuration of a network including a communication apparatus according to a second embodiment;

FIG. 10 is a flow chart showing an entire flow of an identification information deleting process in the second embodiment;

FIG. 11 is a diagram for explaining an example of the identification information deleting process in the second embodiment;

FIG. 12 is a diagram for explaining an example of identification information registered in an identification information registering unit before a network configuration is changed; and

FIG. 13 is a diagram for explaining an example of identification information registered in the identification information storing unit after the network configuration is changed.

### DETAILED DESCRIPTION OF THE INVENTION

Exemplary embodiments of a communication apparatus, a communication method, and a computer program product according to the present invention will be described in detail below with reference to the accompanying drawings.

A communication apparatus according to a first embodiment decides whether, the communication apparatus receives a router advertisement including a network prefix and a default router address from a router, the communication apparatus can be connected to other communication apparatus to which the communication apparatus itself is to be connected or not. When the communication apparatus can be connected to the other communication apparatus, the network prefix and the default router address are registered in a storing unit.

In the first embodiment, the communication apparatus is a home information appliance such as a door sensor, a network camera, a digital camera, or a refrigerator having a limited storing device. A case in which such a communication apparatus communicates with a home appliance management server connected to the communication apparatus through the IPv6 Internet will be exemplified. This is only an example, the method of the proposed method can be applied to any communication apparatus which accesses the IPv6 Internet to realize communication in every network configuration.

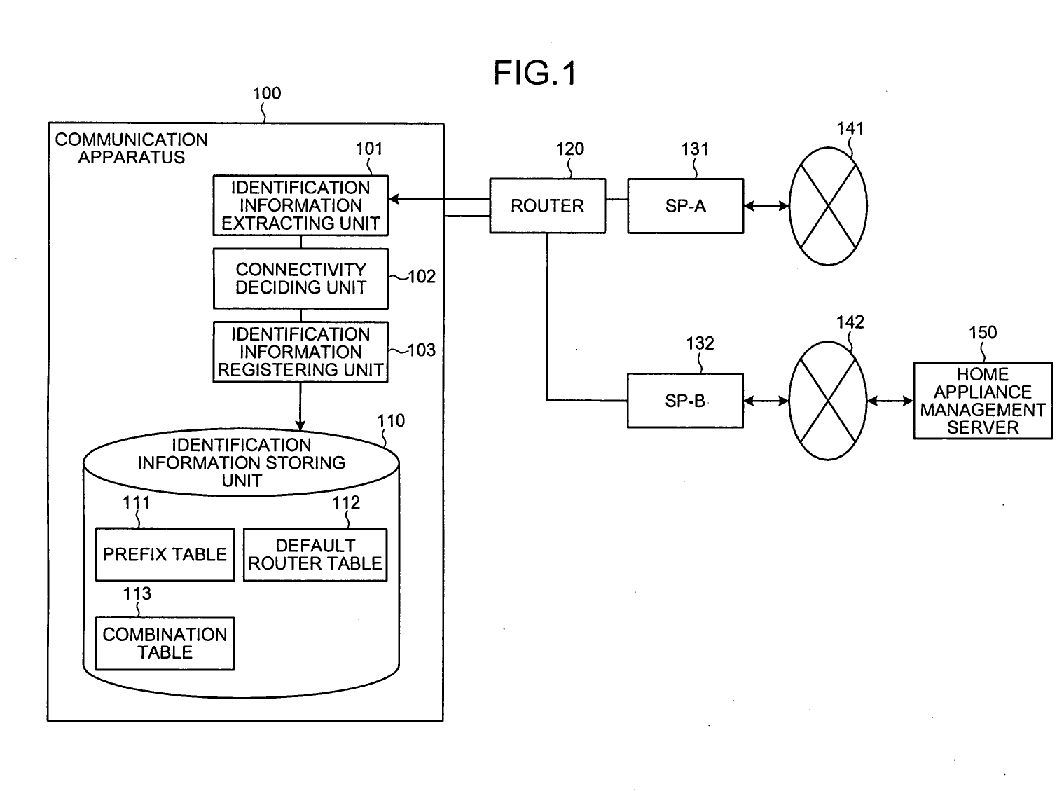

FIG. 1 is a diagram for explaining the entire configuration of a network including a communication apparatus 100 according to the first embodiment. As shown in FIG. 1 the communication apparatus 100 is connected to an SP-A 131 and an SP-B 132 serving as service providers through a router 120 serving as a repeater. The SP-A 131 is connected to a local area network 141 serving as a closed network. The SP-B 132 is connected to the Internet 142, and can communicate with a home appliance management server 150 with which the communication apparatus 100 actually executes communication through the Internet 142.

The router 120 is to select a route of a network which transfers a message with reference to information such as a destination address of a message to be transmitted. The router 120 is to periodically transmit a router advertisement in IPv6 to the connected communication apparatus 100. The router advertisement includes a network prefix and a default router address expressing a network address of the router 120.

The local area network 141 is a closed network environment, for example, corresponds to a network which provides a video-on-demand service or a network which is designed such that specific users can communicate with each other while assuring security. The SP-A 131 is a service provider that provides a connection service to the local area network 141.

The Internet 142 is an IPv6 Internet environment, and the SP-B 132 is a service provider that provides a connection service to the Internet 142.

The home appliance management server 150 communicates with the communication apparatus 100 serving as a home information appliance to execute management of information transmitted from the communication apparatus 100 and control of an operation of the communication apparatus 100. In the first embodiment, the home appliance management server 150 will be exemplified. However, the method of the proposal can be applied to any apparatus that communicates with the communication apparatus 100 through the IPv6 Internet.

The communication apparatus 100 includes an identification information extracting unit 101, a connectivity deciding unit 102, an identification information registering unit 103, and an identification information storing unit 110.

The identification information extracting unit 101 receives a router advertisement transmitted from the router 120 to extract a combination of network prefix and default router address from the received router advertisement. Since a plurality of networks (a plurality of service providers) is connected to one router, the router 120 may transmit a plurality of network prefixes. In this case, the identification information extracting unit 101 extracts a plurality of combinations of network prefix and default router address.

The router advertisement is expressed by RA ((Pa, Pb, . . . ), DR). In this case, the reference symbols Pa and Pb denote network prefixes, and reference symbol DR denotes a default router address. Reference symbol “. . . ” denotes that a plurality of network prefixes can be designated.

For example, when the router 120 having a default router address “DR” is connected to only the service provider SP-A 131 which provides a network service having a network prefix expressed by “Pa”, a router advertisement is expressed by RA(Pa, DR). When the router 120 having a default router address “DR” is connected to the service providers SP-A 131 and SA-B 132 which provide network services having the network prefixes respectively expressed by “Pa” and “Pb”, a router advertisement is expressed by RA((Pa, Pb), DR).

The connectivity deciding unit 102 transmits an echo request message of an ICMP to the home appliance management server 150 by using the combination of network prefix and default router address extracted by the identification information extracting-unit 101, and decides connectivity to the home appliance management server 150 by checking whether the connectivity deciding unit 102 can receive an echo response message which is returned by the home appliance management server 150 in response to the echo request message.

The decision of connectivity is not limited to the method achieved by transmission of an echo request message and reception of an echo response message. Any method which can confirm whether connection to the home appliance management server 150 is possible or impossible may be used.

The identification information registering unit 103 registers the combination of network prefix and default router address which is decided to connect to the home appliance management server 150 by the connectivity deciding unit 102 in the identification information storing unit 110.

The identification information storing unit 110 is a s toring unit which stores a combination of network prefix and default router address, and can be constituted by any generally used storing device such as an bDD (Hard Disk Drive) or a semiconductor memory. The identification information s toring unit 110 separately stores the combination of network prefix and default router address serving as identification information in a prefix table 111, a default router table 112, and a combination table 113.

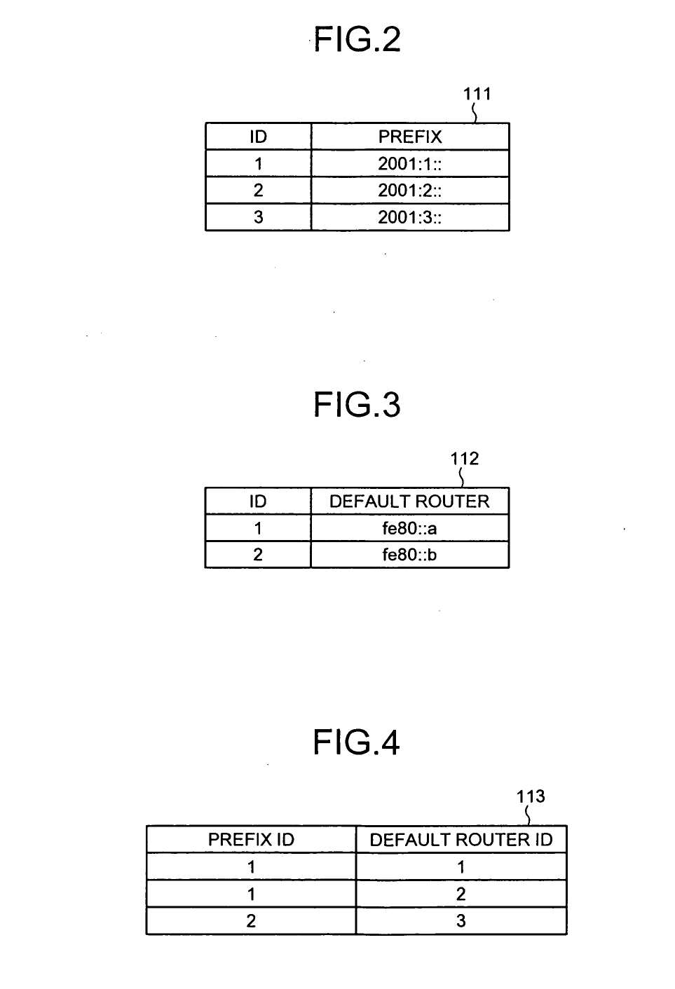

In the prefix table 111, only a network prefix is extracted from the router advertisement and stored. FIG. 2 is a diagram for explaining an example of the data structure of the prefix table 111. As shown in FIG. 2, the prefix table 111 stores an ID for uniquely identifying a network prefix and the network prefix in association with each other.

In the default router table 112, only a default router address is extracted from the router advertisement and stored. FIG. 3 is a diagram for explaining an example of the data structure of the default router table 112. As shown in FIG. 3, the default router table 112 stores an ID for uniquely identifying a default router address and the default router address in association with each other.

The combination table 113 stores information for associating a network prefix stored in the prefix table 111 and a default router address stored in the default router table 112 with each other. FIG. 4 is a diagram for explaining an example of the data structure of the combination table 113. As shown in FIG. 4, the combination table 113 stores a prefix ID expressing an ID in the prefix table 111 and a default router ID expressing an ID in the default router table 112 in association with each other.

In this manner, the ID for identifying a network prefix and an ID for identifying a default router address are managed in association with each other, so that the combination of both IDs can be held.

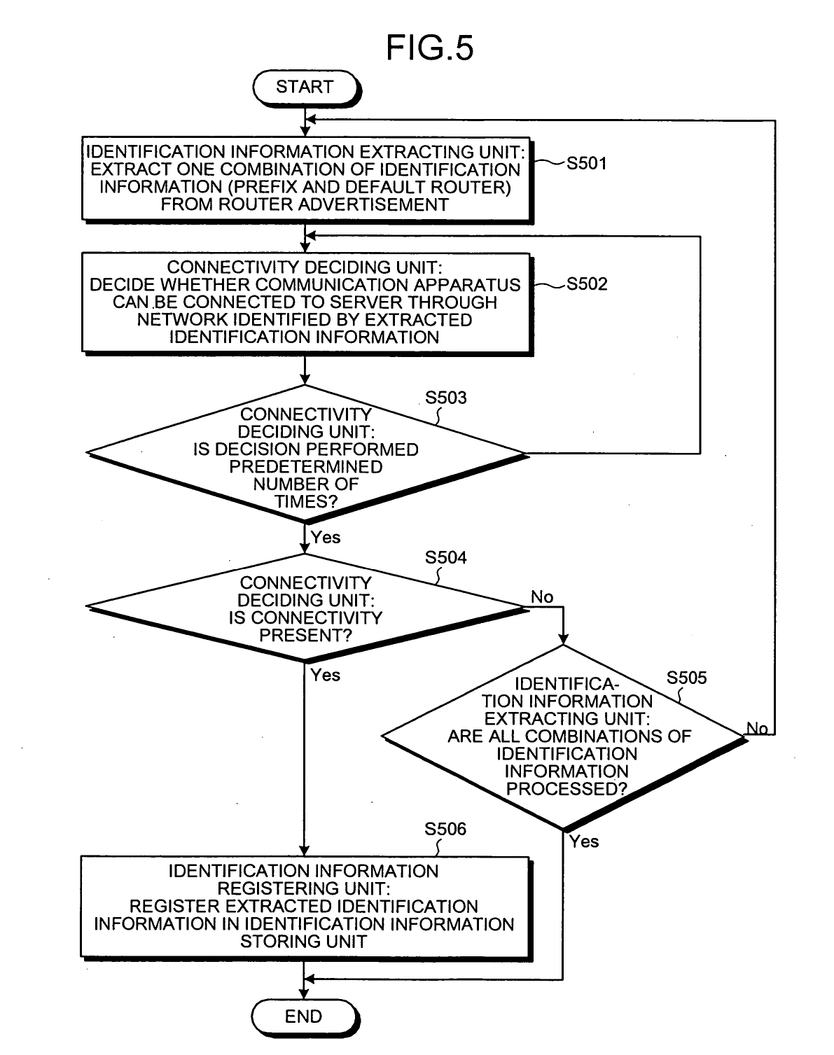

An identification information registering process performed by the communication apparatus 100 according to the first embodiment constituted as described above will be described below. FIG. 5 is a flow chart showing an entire flow of the identification information registering process in the first embodiment.

The identification information extracting unit 101 extracts one combination of network prefix and default router address as identification information from the router received from the router 120 (step S501).

The connectivity deciding unit 102 decides whether the communication apparatus can be connected to the home appliance management server 150 through a network identified by the network prefix and the default router address extracted by the identification information extracting unit 101 (step S502). More specifically, the connectivity deciding unit 102 transmits an echo request message (ICMP ECHO_REQUEST) of ICMP to the home appliance management server 150, and decides connectivity to the home appliance management server 150 by checking whether connection can be performed or not by checking whether the connectivity deciding unit 102 can receive an echo response message (ICMP ECHO_REPLY) of ICMP transmitted by the home appliance management server 150 in response to the transmitted echo request message or not.

At this time, the connectivity deciding unit 102 sets the address of the home appliance management server 150 as a destination address of an IP header (to be referred to as an IPv6 header hereinafter) of an IPv6 packet and sets the network address of the communication apparatus 100 as a source address of the IPv6 header. The echo request message is transmitted to the home appliance management server 150 through the router 120 corresponding to the extracted default router address. In this case, as the address of the home appliance management server 150, address stored in the identification information storing unit 110 or another storing unit in advance is used.

The connectivity deciding unit 102 sets the extracted default router address as a destination address of an extension header which designates a routing option of the IPv6 packet, sets the extracted default router address as the destination address of the IPv6 header, and sets the network address of the communication apparatus 100 generated from the extracted network prefix and the interface ID serving as an ID for identifying the apparatus itself as the source address of the IPv6 header, so that the echo request message may be transmitted.

In step S502, after the connectivity to the home appliance management server 150 is decided, the connectivity deciding unit 102 determines whether the deciding process is executed a predetermined number of times or not (step S503). When the deciding process is not executed the predetermined number of times (step S503: No), the control flow returns to step S502 to repeat the deciding process. In this manner, the possibility that no conductivity is decided due to temporary abnormality of a network circuit can be reduced although the network is originally connectable.

In step S503, when it is determined that the deciding process is executed the predetermined number of times (step S503: Yes), the connectivity deciding unit 102 determines whether the conductivity to the home appliance management server 150 is present or not (step S504).

When the connectivity deciding unit 102 determines that the connectivity is not present (step S504: No), the identification information extracting unit 101 determines whether all the combinations of network prefix and default router address are processed or not (step S505). This is because, since the router advertisement can include a plurality of network prefixes, connectivity to the home appliance management server 150 must be decided to all the combinations of network prefix and default router address.

In step S505, when the identification information extracting unit 101 determines that all the combinations of network prefix and default router address are not processes (step S505: No), the control flow returns to the process of extracting the combination of network prefix and default router address in step S501 to repeat the process.

When the identification information extracting unit 101 determines that all the combinations of network prefix and default router address (step S505: Yes), a connectable network is not present. For this reason, the process is ended without registering the combinations of network prefix and default router address in the identification information storing unit 110.

When the connectivity deciding unit 102 determines in step S504 that connectivity is present (step S504: Yes), the identification information registering unit 103 registers the extracted combination of network prefix and default router address in the identification information storing unit 110 (step S506).

When the connectivity deciding unit 102 decides that determines that the network is connectable only once in the deciding processes performed the predetermined number of times in principle, it is determined that the connectivity is present. Therefore, even though a plurality of routers or a plurality of network prefixes are present, and even though a plurality of routers of networks which can be connected to the home appliance management server 150 are present, a combination of network prefix and default router address which is decided to obtain conductivity at the beginning is registered in the identification information storing unit 110. Therefore, even though another network is more stably connectable, identification information of the network decided to have connectivity at the beginning is registered.

For this reason, the decision of connectivity is repeated to all the combinations of network prefix and default router address predetermined numbers of times, respectively. The results are compared with each other, so that a combination of network prefix and default router address to be registered may be determined.

For example, a combination which is decided to be connectable a large number of times may be registered. When combinations are decided to be connectable equal numbers of times, a combination having short time required until an echo response message returns may be registered. With this configuration, a network having a higher and more stable connectivity can be selected.

The deciding process may be set to be performed only once, i.e., the predetermined number of times may be set at 1. With this configuration, a processing load on a communication apparatus such as a home information appliance having limited resources can be reproduced.

When a combination of network prefix and default router address is registered in the identification information storing unit 110, the connectivity deciding unit 102 may be designed not to execute a decision of connectivity. This is because, since the route of the network which can be connected to the home appliance management server 150 has been known, the connectivity to the home appliance management server 150 need not be newly decided.

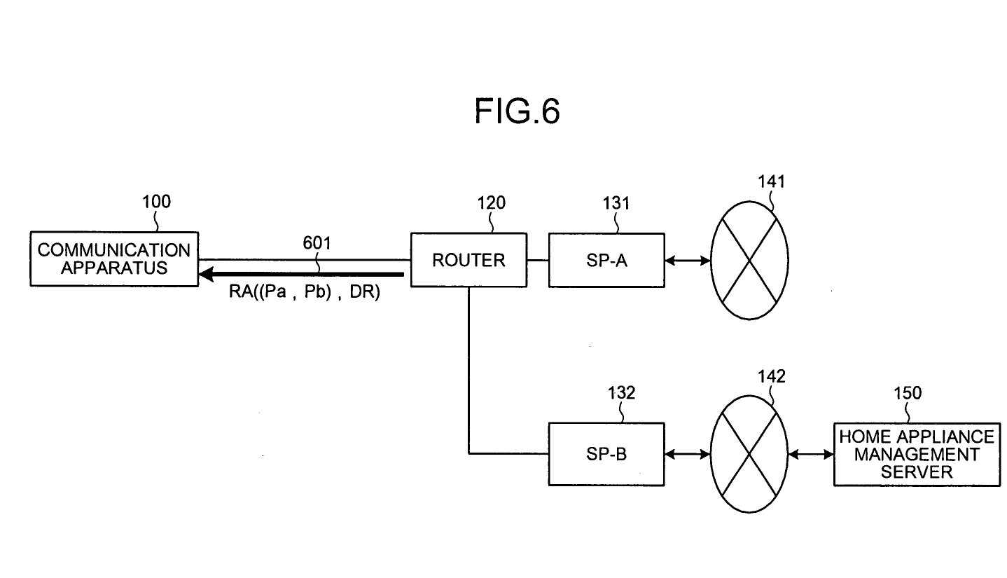

A specific example of an identification information registering process by the communication apparatus 100 according to the first embodiment constituted described above will be described below. FIG. 6 is a diagram for explaining an example of the identification information registering process in the first embodiment.

As shown in FIG. 6 the communication apparatus 100 is connected to the router 120, the SP-A 131, the SP-B 132, the local area network 141, the Internet 142, and the home appliance management server 150 as in the configuration in FIG. 1.

In this case, from the router 120, a router advertisement 601 represented by RA((Pa, Pb), DR) is transmitted. Reference symbol “Pa” denotes-a network prefix allocated to the SP-A 131, and reference symbol “Pb” denotes a network prefix allocated to the SP-B 132. Reference symbol “DR” denotes a network address of the router 120, i.e., a default router address.

The identification information extracting unit 101 extracts (Pa, DR) as one combination of identification information from the router advertisement 601 (step S501). The connectivity deciding unit 102 decides whether the communication apparatus can be connected to the home appliance management server 150 through the network identified by the identification information, i.e., the local area network 141 provided by the SP-A 131 (step S502).

Since the local area network 141 is not connected to the home appliance management server 150, even though an echo request message is transmitted a predetermined number of times, no echo response message is not returned, and connectivity is decided to be absent (step S503 and step S504: No). Therefore, the identification information extracting unit 101 extracts the next combination of identification information (Pb, DR) to repeat the process (step S505 and step S501).

The connectivity deciding unit 102 decides whether the communication apparatus can be connected to the home appliance management server 150 through the network identified by the identification information, i.e., the Internet 142 provided by the SP-B 132 (step S502).

Since the Internet 142 is connected to the home appliance management server 150, if a network failure does not occur, the connectivity deciding unit 102 decides the presence of conductivity (step S504: Yes), and the identification information registering unit 103 registers the identification information (Pb, DR) in the identification information storing unit 110 (step S506).

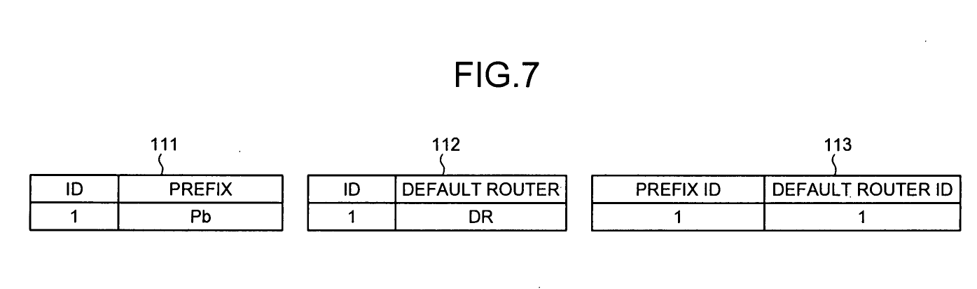

FIG. 7 is a diagram for explaining an example of the identification information registered in the identification information storing unit 110 by the identification information registering unit 103. As shown in FIG. 7, in the prefix table 111 of the identification information storing unit 110, a network prefix “Pb” is registered by setting an ID as 1. In the default router table 112, a default router address “DR” is registered by setting an ID as 1. In the combination table 113, a record including prefix ID=1 and default router ID=1 representing each combination of IDs is registered.

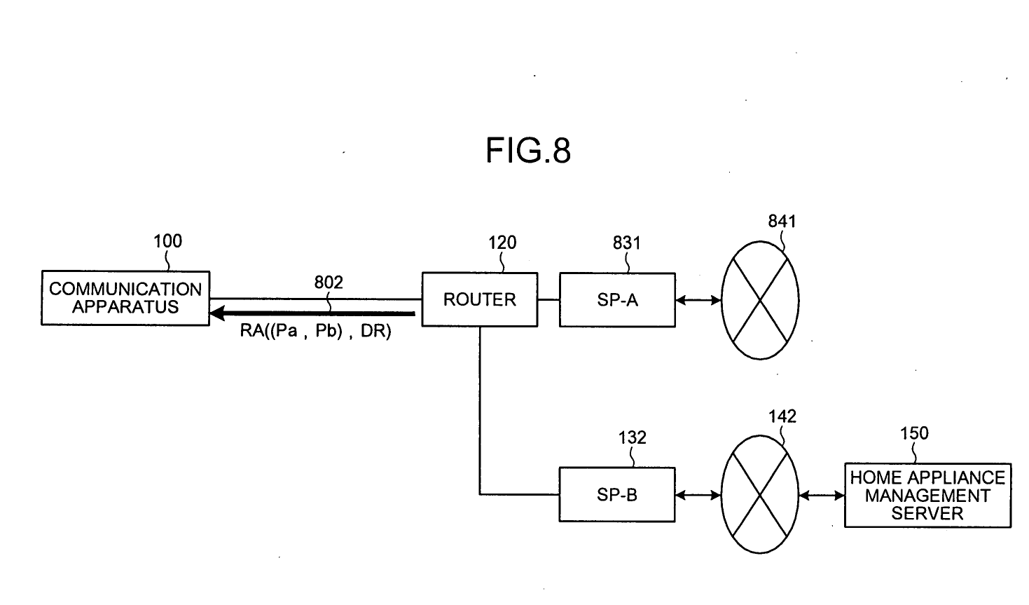

Another specific example of the identification information registering process performed by the communication apparatus 100 according to the first embodiment will be described below. FIG. 8 is a diagram for explaining an example of the identification information registering process in the first embodiment.

As shown in FIG. 8, the communication apparatus 100 is connected to the router 120, an SP-A 831, the SP-B 132, the Internet 841, the Internet 142, and the home appliance management server 150. In this manner, the network configuration in FIG. 8 is different from that in FIG. 6 in that not only the SP-B 132 but also the SP-A 831 provides a connection service to the Internet 841 which can be connected to the home appliance management server 150.

In this case, a router advertisement transmitted from the router 120 is expressed by RA((Pa, Pb), DR) as in FIG. 6. When the identification information extracting unit 101 extracts (Pa, DR) as the first combination of identification information from the router advertisement 601, the connectivity deciding unit 102 decides that the communication apparatus 100 can be connected to the home appliance management server 150 through the SP-A 831 (step S504: Yes). The identification information (Pa, DR) is registered in the identification information storing unit 110 (step S506).

At this time, as described above, it is considered determination of identification information which is registered by comparing results decided by using all the combinations of identification information. In this case, even though the identification information (Pa, DR) is decided as the presence of connectivity in step S504, the identification information is not immediately registered, and the control flow returns to step S501 to perform a deciding process for the combination of identification information (Pb, DR).

As a result, for example, when the number of times of decision of being connectable in the combination of identification information (Pb, DR) is larger than that in the combination of identification information (Pa, DR), or when time until an echo response message returns is shorter than that of the combination of identification information (Pa, DR), the identification information (Pb, DR) is registered in the identification information storing unit 110.

With the above configuration, for example, even though the Internet 142 provided by the SP-B 132 (will be decided later) has higher stability in connection, identification information of the Internet 142-provided by the SP-B 132 can be registered.

In this manner, in the communication apparatus 100 according to the first embodiment, when a router advertisement including a network prefix and a default router address is received from the router 120, all the received network prefixes and the received default router addresses are not stored. It is decided whether the communication apparatus 100 can be connected to the home appliance management server 150 through a network identified by the network prefix and the default router address, and the network prefix and the default router address are registered in the identification information storing unit 110 only when the communication apparatus 100 can be connected to the home appliance management server 150. More specifically, even though the size of the identification information storing unit 110 is limited, unnecessary information is excluded to make it possible to register only a requisite minimum of information which can assure communication connectivity. For this reason, even a communication apparatus such as a home information appliance having limited resources can stably maintain communication connectivity.

A communication apparatus according to the second embodiment periodically retrieves identification information consisting of a network prefix and a default router address registered in a storing unit in advance from the storing unit and decides whether the communication apparatus can be connected to other communication apparatus to which the communication apparatus itself is to be connected through a network identified by the retrieved identification information or not. When the communication apparatus cannot be connected to the other communication apparatus, the retrieved network prefix and the retrieved default router address are deleted from the storing unit.

More specifically, in the communication apparatus according to the second embodiment, the identification information of a network the connectivity of which is lost due to a change in network configuration or the like is made to able to be deleted. Unnecessary information is excluded to register only a requisite minimum of information which can assure communication connectivity, so that the communication connectivity in the communication apparatus such as a home information appliance having limited resources can be more stably maintained.

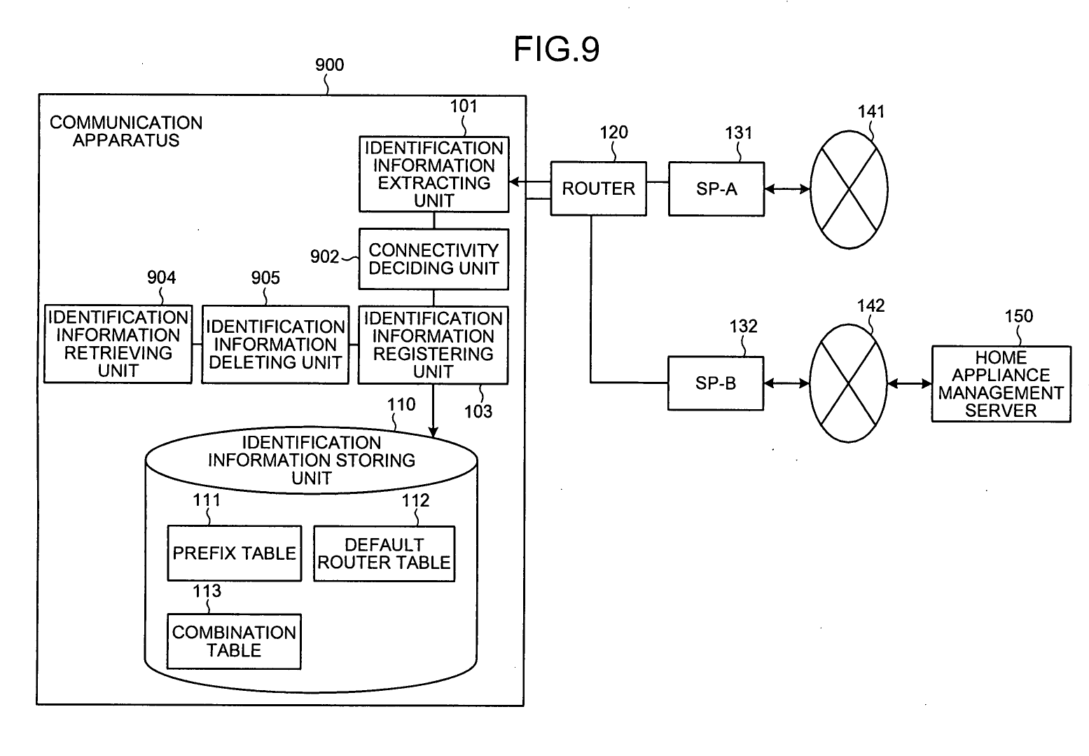

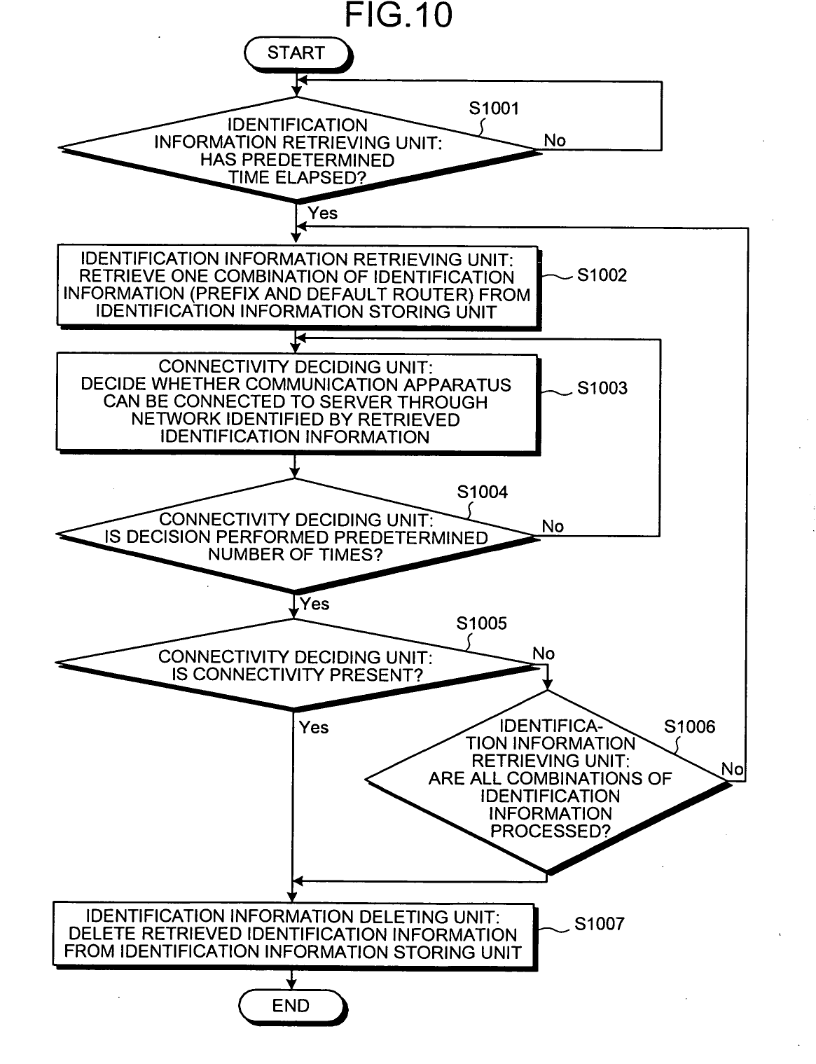

FIG. 9 is a diagram for explaining the entire configuration of a network including a communication apparatus 900 according to the second embodiment. As shown in FIG. 9, the communication apparatus 900 is connected to the router 120, the SP-A 131, the SP-B 132, the local area network 141, the Internet 142, and the home appliance management server 150 as in the configuration in FIG. 1.

The second embodiment is different from the first embodiment in addition of an identification information retrieving unit 904 and an identification information deleting unit 905 and a function of a connectivity deciding unit 902. Since the other configuration and functions are the same as those in FIG. 1 which is a block diagram showing the configuration of the communication apparatus 100 according to the first embodiment, the same reference numerals as in FIG. 1 denote the same parts in FIG. 9, and the description thereof is not repeated.

The identification information retrieving unit 904 is to retrieve a combination of network prefix and default router address stored in the identification information storing unit 110 from the identification information storing unit 110 each time a predetermined period of time has elapsed.

The connectivity deciding unit 902 is different from the connectivity deciding unit 102 according to the first embodiment in that the connectivity deciding unit 902 uses not only a combination of network prefix and default router address extracted by the identification information extracting-unit 101 but also the combination of network prefix and default router address retrieved by the identification information retrieving unit 904 from the identification information storing unit 110 to decide connectivity to the home appliance management server 150.

The identification information deleting unit 905 causes the connectivity deciding unit 902 to delete a combination of network prefix and default router address in which the communication apparatus 900 can be connected to the home appliance management server 150 from the identification information storing unit 110.

Since the identification information registering process in the communication apparatus 900 according to the second, embodiment is the same as the process in FIG. 5 described in the communication apparatus 100 according to the first embodiment, the description thereof is not repeated.

An identification information deleting process performed by the communication apparatus 900 according to the second embodiment having the above configuration will be described below. FIG. 10 is a flow chart showing an entire flow of the identification information deleting process according to the second embodiment.

The identification information retrieving unit 904 determines whether a predetermined period of time has elapsed or not (step S1001). This determination is performed to periodically check whether identification information of a network the connectivity of which is lost is present in the identification information storing unit 110 or not. Since the check is performed together with transmission/reception of a message, an appropriate period of time must be set as an interval for the periodic determination not to increase a load acting on the network.

The identification information retrieving unit 904 retrieves one combination of network prefix and default router address from the identification information storing unit 110 as identification information from the identification information storing unit 110 (step S1002).

Since the contents of a connectivity deciding process executed in steps S1003 to S1005 are the same as those in steps S502 to S504 in the communication apparatus 100 according to the first embodiment except that the identification information retrieved from the identification information storing unit 110 is used in place of the identification information received from the router 120, the description thereof is not repeated.

In step S1005, when the connectivity deciding unit 902 determines the absence of connectivity (step S1005: YES), the identification information deleting unit 905 deletes the retrieved combination of network-prefix and default router address from the identification information storing unit 110 (step S1007).

When the connectivity deciding unit 902 determines the absence of connectivity, the identification information is not immediately deleted, the cycle is shortened to transmit an echo request message and receive an echo response message again. According to the result, the connectivity may be decided. In this manner, when a temporary network failure occurs, the possibility of erroneously deciding the absence of connectivity can be reduced.

In step S1005, when the connectivity deciding unit 902 determines the presence of connectivity (step S1005: No), the identification information retrieving unit 904 determines whether all combinations of network prefix and default router address are processed or not (step S1006).

When it is determined that all the combinations of network prefix and default router address are not processed (step S1006: No), the control flow returns to the process of retrieving a combination of network prefix and default router address in step S1002 to repeat the process. When it is determined that all the combinations of network prefix and default router address are processed (step S1006: Yes), the identification information deleting process is ended.

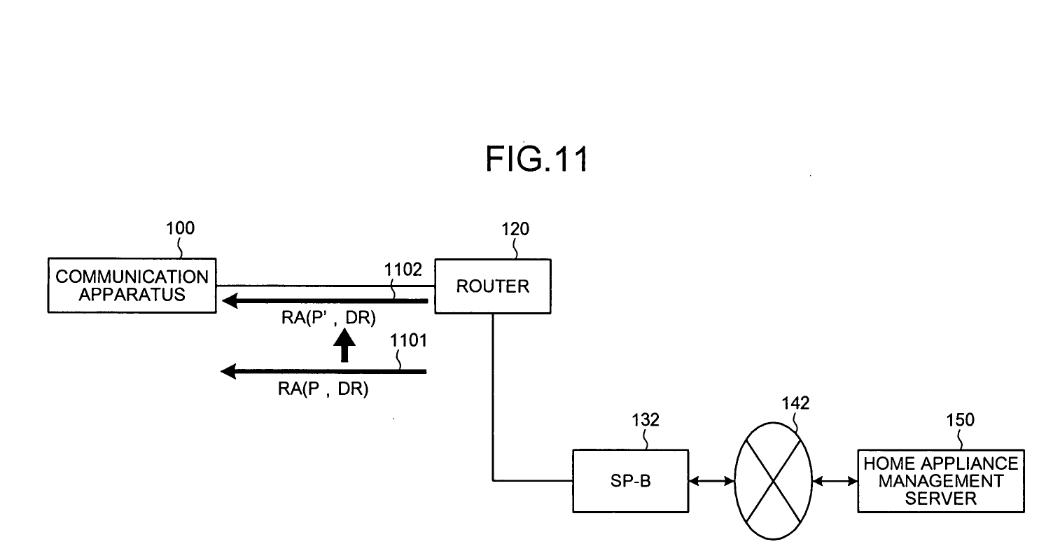

A specific example of the identification information deleting process performed by the communication apparatus 900 according to the second embodiment having the above configuration will be described below. FIG. 11 is a diagram for explaining an example of the identification information deleting process in the second embodiment.

As shown in FIG. 11, the communication apparatus 900 is connected to the home appliance management server 150 through the router 120, the SP-B 132, and the Internet 142. In this case, although a network prefix represented by “P” is allocated to the SP-B 132 at the beginning, it is assumed that the network prefix is changed into a network prefix represented by “P′” by changing the network configurations.

In this case, before the change, a router advertisement 1101 represented by RA(P, DR) is transmitted from the router 120, and the presence of connectivity is decided by the connectivity deciding unit 902. For this reason, the network prefix “P” and the default router address “DR” are registered in the identification information storing unit 110 by the identification information registering unit 103. This process is executed by the same procedure as that of the identification information registering process described in FIG. 5 in the first embodiment.

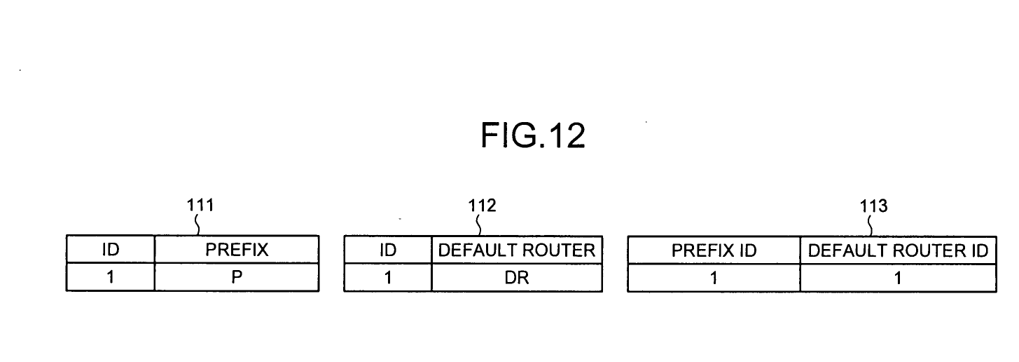

FIG. 12 is a diagram for explaining an example of identification information registered in the identification information storing unit 110 by the identification information registering unit 103 before the network configuration is changed. As shown in FIG. 12, the network prefix “P” is registered in the prefix table 111 of the identification information storing unit 110 by setting the ID as 1. In the default router table 112, the default router address “DR” is registered by setting the ID as 1. In the combination table 113, a record in which prefix ID =1 and default router ID=1 expressing each combination of IDs is registered.

When the network configuration is changed, the identification information retrieving unit 904 periodically retrieves a network prefix and a default router address from the identification information storing unit 110 to obtain a combination of network prefix “P” and default router address “DR” (step S1001 and step S1002).

The connectivity deciding unit 902 decides connectivity to the home appliance management server 150 through the network identified by the-network prefix “P” and the default router address “DR”. However, since the network represented by the network prefix “P” is not present, it is decided that the connectivity is absent (step S1005: No). Therefore, the identification information deleting unit 905 deletes the combination of network prefix “P” and default router address “DR” from the identification information storing unit 110 (step S1007).

Thereafter, a router advertisement 1102 represented by RA(P′, DR) and obtained after the network configuration is changed is transmitted from the router 120 to cause the connectivity deciding unit 902 to decide the presence of connectivity. For this reason, the network prefix “P′” and the default router address “DR” are registered in the identification information storing unit 110 by the identification information registering unit 103. This process is executed by the same procedure as that of the identification information registering process described in FIG. 5 in the first embodiment.

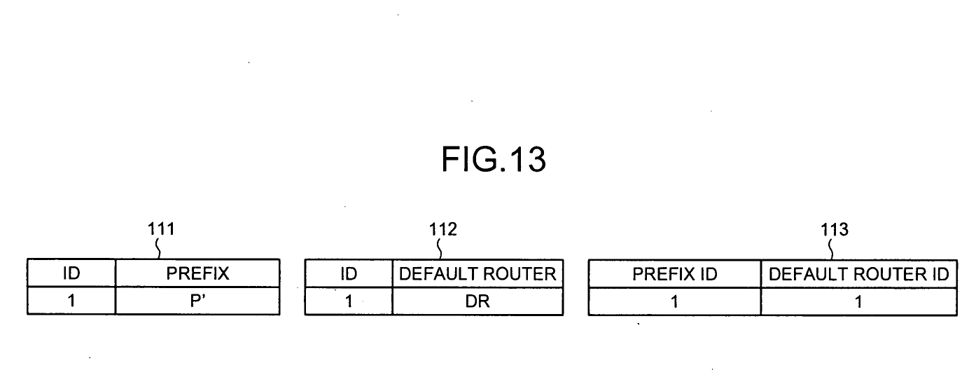

FIG. 13 is a diagram for explaining an example of identification information registered in the identification information storing unit 110 by the identification information registering unit 103 after the network configuration is changed. As shown in FIG. 13, the network prefix “P′” is registered in the prefix table 111 of the identification information storing unit 110 by setting the ID as 1. In the default router table 112, the default router address “DR” is registered by setting the ID as 1. In the combination table 113, a record in which prefix ID=1 and default router ID=1 expressing each combination of IDs is registered.

In the communication apparatus 900 according to the second embodiment, identification information consisting of a network prefix and a default router address is periodically retrieved from the identification information storing unit 110, and it is decided whether the communication apparatus 900 can be connected to the home appliance management server 150 through the network identified by the retrieved identification information. When the communication apparatus 900 cannot be connected to the home appliance management server 150, the retrieved identification information is deleted from the identification information storing unit 110. For this reason, the identification information of a network the connectivity of which is lost by a change in network configuration or the like is excluded to make it possible to store only a requisite minimum of information which can assure communication connectivity. In this manner, communication connectivity in a communication apparatus such as a home information appliance having limited resources can be more stably maintained.

A communication program executed by the communication apparatus according to the-first or second embodiment is provided such that the communication program is incorporated in a ROM (Read Only Memory) or the like in advance.

The communication program executed by the communication apparatus according to the first or second embodiment may be provided such that the communication program is recorded as a file of an installable form or an executable form on a computer readable recording medium such as a CD-ROM (Compact Disk Read Only Memory), a flexible disk (FD), a CD-R (Compact Disk Recordable), or a DVD (Digital Versatile Disk).

The communication program executed by the communication apparatus according to the first or second embodiment is stored in a computer connected to a network such as the Internet, and is caused to be downloaded through the network to provide the communication program. The communication program executed by the communication apparatus according to the first or second embodiment may be provided or delivered through a network such as the Internet.

The communication program executed by the communication apparatus according to the first or second embodiment has a module configuration including the respective units (the identification information extracting unit, the connectivity deciding unit, the identification information registering unit, the identification information retrieving unit, and the identification information deleting unit). As actual hardware, a CPU (Central Processing Unit) reads the communication program from the ROM and executes the communication program to load the units on a main memory device, so that the units are generated on the main memory device.

Additional advantages and modifications will readily occur-to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus connectable to a network repeater comprising:
a receiving unit that receives a data signal sent from the network repeater, the data signal including identification information for identifying a network;
an identification information extracting unit that extracts the identification information from the data signal;
a connectivity deciding unit that decides whether a connection to other communication apparatus through the network identified by the identification information is possible; and
a storing unit that stores the identification information when the connectivity deciding unit decides that the connection to the other communication apparatus is possible.

2. The communication apparatus according to claim 1, further comprising:
an identification information retrieving unit that retrieves for the identification information at a predetermined time interval from the storing unit; and
an identification information deleting unit that deletes from the storing unit the identification information obtained as a result of the retrieving by the identification information retrieving unit,
wherein the connectivity deciding unit decides whether the connection to the other communication apparatus through the network identified by the identification information obtained as the result of the retrieving by the identification information retrieving unit is possible, and
the identification information deleting unit deletes the identification information from the storing unit when the connectivity deciding unit decides that the connection to the other communication apparatus is not possible.

3. The communication apparatus according to claim 2,
wherein the connectivity deciding unit decides whether the connection by the identification information is possible again after time shorter than the predetermined time has elapsed when the connection to the other communication apparatus is not possible.

4. The communication apparatus according to claim 1,
wherein the connectivity deciding unit does not decide whether the connection to the other communication apparatus based on the identification information extracted by the identification information extracting unit when the storing unit stores the identification information.

5. The communication apparatus according to claim 1,
wherein when the identification information extracted by the identification information extracting unit is constituted by pieces of identification information, the connectivity deciding unit decides whether the connection to the other communication apparatus through networks identified by the pieces of identification information is possible, and
the storing unit stores, of the pieces of identification information, the identification information which identifies a network which is decided to be connectable by the connectivity deciding unit.

6. The communication apparatus according to claim 1,
wherein the identification information extracting unit extracts a router advertisement including a network prefix and a network address of the network repeater as the identification information.

7. The communication apparatus according to claim 1,
wherein the connectivity deciding unit transmits an echo request message of the Internet Control Message Protocol and decides whether the connection is possible by checking whether an echo response message of the Internet Control Message Protocol transmitted from the other communication apparatus is received in response to the echo request message.

8. The communication apparatus according to claim 7,
wherein the connectivity deciding unit transmits the echo request message a plurality of times and decides whether the connection to the other communication apparatus is possible based on a plurality of receiving results of an echo response message in response to the echo request message.

9. A communication method for communicating between a communication apparatus and other communication apparatus through a network repeater comprising:
receiving a data signal sent from the network repeater the data signal including identification information for identifying a network;
extracting identification information from the data signal;
deciding whether a connection of the communication apparatus to the other communication apparatus through the network identified by the identification information is possible; and
storing the identification information in a storing unit when it is decided that the connection to the other communication apparatus is possible.

10. A computer program product having a computer readable medium including programmed instructions for communicating between a communication apparatus through a network repeater, wherein the instructions, when executed by a computer, cause the computer to perform:
receiving a data signal sent from the network repeater the data signal including identification information for identifying a network;
extracting identification information from the data signal;
deciding whether a connection of the communication apparatus to the other communication apparatus through the network identified by the identification information is possible; and
storing the identification information in a storing unit when it is decided that the connection to the other communication apparatus is possible.
